(19) United States
(12) Patent Application Publication
(10) Pub. No.: US 2025/0140790 A1
(43) Pub. Date: May 1, 2025

(54) Non-Aqueous Rechargeable Battery and Method for Manufacturing Non-Aqueous Rechargeable Battery

(71) Applicant: TOYOTA BATTERY Co., Ltd., Shizuoka (JP)

(72) Inventors: Kazuya Taga, Hamamatsu-shi (JP); Shotaro Deguchi, Toyohashi-shi (JP)

(21) Appl. No.: 18/924,865

(22) Filed: Oct. 23, 2024

(30) Foreign Application Priority Data
Oct. 27, 2023 (JP) 2023185032

(51) Int. Cl. H01M 4/36; H01M 4/02; H01M 4/60; H01M 4/62

(52) U.S. Cl. CPC H01M 4/364; H01M 4/602; H01M 4/625; H01M 2004/021; H01M 2004/028

(57) ABSTRACT

A non-aqueous rechargeable battery includes a cathode sheet, an anode sheet, and a non-aqueous electrolyte solution. A cathode mixture forming the cathode sheet contains a cathode active material, a fibrous conductive material, a hydroxy-NMP, and a cathode binder. An amount of the hydroxy-NMP present per unit area of the cathode active material is between 0.0026 μg/cm² and 0.0150 g/cm², inclusive.

### CROSS-REFERENCE TO RELATED APPLICATIONS

This application is based upon and claims the benefit of priority from prior Japanese Patent Application No. 2023-185032, filed on Oct. 27, 2023, the entire contents of which are incorporated herein by reference.

### BACKGROUND

### 1. Field

The following description relates to a non-aqueous rechargeable battery and a method for manufacturing a non-aqueous rechargeable battery.

### 2. Description of Related Art

A non-aqueous rechargeable battery includes an electrode body, in which a cathode sheet and an anode sheet are stacked with a separator arranged in between, and an electrolyte solution. A cathode mixture containing a cathode active material is applied to a cathode substrate of the cathode sheet. Japanese Laid-Open Patent Publication No. 2021-163626 describes a cathode mixture of a non-aqueous rechargeable battery that contains, as a conductive material, at least one type of additive selected from a cathode active material, a binder, a fibrous conductive material, a non-ionic polymer dispersant, lithium hydroxide, and a lithium salt of a weak acid.

### SUMMARY

A non-aqueous rechargeable battery that contains a fibrous carbon material in a cathode mixture only requires a relatively small amount of the fibrous conductive material. Thus, when the non-aqueous rechargeable battery is energized, side reactions of the cathode active material and the electrolyte solution will increase. In this case, hydrogen fluoride (HF) produced as a by-product may accelerate deterioration of the cathode.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous rechargeable battery includes a cathode sheet, an anode sheet, and a non-aqueous electrolyte solution. A cathode mixture forming the cathode sheet contains a cathode active material, a fibrous conductive material, a hydroxy-NMP, and a cathode binder. An amount of the hydroxy-NMP present per unit area of the cathode active material is between 0.0026 μg/cm² and 0.0150 μg/cm², inclusive.

In the above non-aqueous rechargeable battery, the fibrous conductive material may have an average fiber length between 100 nm and 1000 nm, inclusive. A ratio of the fibrous conductive material contained in the cathode mixture may be between 0.5 wt % and 1.0 wt %, inclusive.

In the above non-aqueous rechargeable battery, the cathode active material may have a specific surface area between 1.7 m²/g and 2.5 m²/g, inclusive.

In another general aspect, a method for manufacturing a non-aqueous rechargeable battery is provided. The battery includes a cathode sheet, an anode sheet, and a non-aqueous electrolyte solution. A cathode mixture forming the cathode sheet contains a cathode active material, a fibrous conductive material, a hydroxy-NMP, and a cathode binder. A ratio of the hydroxy-NMP contained in an NMP is between 215 ppm and 1300 ppm, inclusive. The NMP serves as a solvent. The method includes applying a paste of the cathode mixture, liquefied with the solvent, to a cathode substrate forming the cathode sheet, and drying the paste.

In the above method, the fibrous conductive material may have an average fiber length between 100 nm and 1000 nm, inclusive. A ratio of the fibrous conductive material contained in the cathode mixture may be between 0.5 wt % and 1.0 wt %, inclusive.

In the above method, the cathode active material may have a specific surface area between 1.7 m²/g and 2.5 m²/g, inclusive.

Other features and aspects will be apparent from the following detailed description, the drawings, and the claims.

### BRIEF DESCRIPTION OF THE DRAWINGS

FIG. 1 is a perspective view schematically showing the structure of a battery cell in accordance with an embodiment of a non-aqueous rechargeable battery.

FIG. 2 is a diagram of an electrode body in accordance with the embodiment in a partially unrolled state.

FIG. 3 is a diagram showing an NMR spectrum of a cathode mixture not containing hydroxy-NMP.

FIG. 4 is a model diagram of the cathode active material not containing hydroxy-NMP.

FIG. 5 is a model diagram of the cathode active material not containing hydroxy-NMP.

FIG. 6 is a diagram showing an NMR spectrum of the cathode mixture containing hydroxy-NMP in accordance with the embodiment.

FIG. 7 is a model diagram of the cathode active material containing hydroxy-NMP in accordance with the embodiment.

FIG. 8 is a model diagram of the cathode active material containing hydroxy-NMP in accordance with the embodiment.

FIG. 9 is a graph showing the relationship of a hydroxy-NMP amount and a deterioration rate.

FIG. 10 is a graph showing the relationship of the hydroxy-NMP amount and a reaction resistance.

FIG. 11 is a table showing Examples and Comparative Examples of the non-aqueous rechargeable battery.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

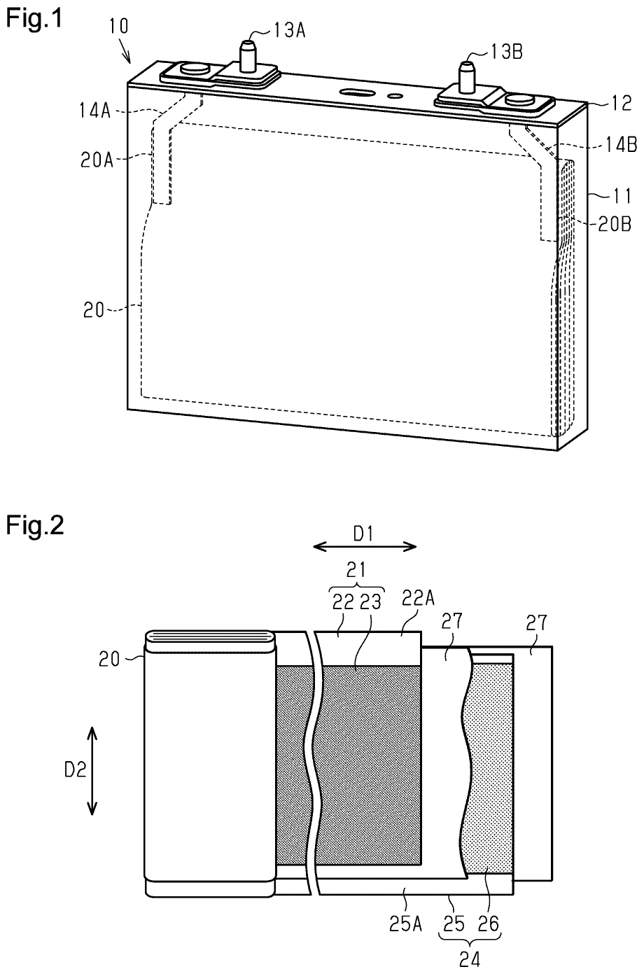

A non-aqueous rechargeable battery and a method for manufacturing a non-aqueous rechargeable battery in accordance with an embodiment will now be described with reference to FIGS. 1 to 8. A lithium-ion rechargeable battery will be described as an example of a non-aqueous rechargeable battery.

### Lithium-Ion Rechargeable Battery 10

As shown in FIG. 1, a lithium-ion rechargeable battery 10 is a battery cell. Multiple lithium-ion rechargeable batteries 10 are combined and encapsulated in a resin or metal case to form a battery pack. The battery pack is used in a hybrid electric vehicle or a battery electric vehicle.

The lithium-ion rechargeable battery 10 includes a battery case 11 and a lid 12. The battery case 11 is box-shaped and has an opening in the upper side of the battery case 11. The lid 12 closes the opening of the battery case 11. The battery case 11 and the lid 12 are formed from a metal such as aluminum or an aluminum alloy. The lithium-ion rechargeable battery 10 forms a sealed battery container by attaching the lid 12 to the battery case 11.

The lid 12 includes a cathode external terminal 13A and an anode external terminal 13B. The cathode external terminal 13A and the anode external terminal 13B are used when charging and discharging the lithium-ion rechargeable battery 10. The battery case 11 accommodates an electrode body 20. An outer insertion film (not shown) is inserted between the battery case 11 and the electrode body 20. A cathode current collector portion 20A, which is the cathode end of the electrode body 20, is electrically connected by a cathode current collector member 14A to the cathode external terminal 13A. An anode current collector portion 20B, which is the anode end of the electrode body 20, is electrically connected by an anode current collector member 14B to the anode external terminal 13B. Further, a non-aqueous electrolyte solution is injected into the battery case 11 through an injection hole (not shown). The cathode external terminal 13A and the anode external terminal 13B do not have to be shaped as shown in FIG. 1 and may have any shape.

### Electrode Body 20

As shown in FIG. 2, the electrode body 20 is a flattened roll formed by rolling a stack of strips of a cathode sheet 21, an anode sheet 24, and separators 27. The cathode sheet 21, the anode sheet 24, and the separators 27 are stacked so that their long sides are parallel to a longitudinal direction D1. Prior to rolling, the cathode sheet 21, the separator 27, the anode sheet 24, and the separator 27 are stacked in this order.

### Cathode Sheet 21

The cathode sheet 21 includes a cathode current collector 22 and a cathode mixture layer 23. The cathode current collector 22 is a strip of a cathode substrate foil. The cathode mixture layer 23 is arranged on each of the two opposing surfaces of the cathode current collector 22. One end of the cathode current collector 22 in a widthwise direction D2 includes a cathode uncoated portion 22A where the cathode mixture layer 23 is not formed such that the cathode current collector 22 is exposed.

The cathode current collector 22 may be a foil of a metal such as aluminum or an alloy having aluminum as a main component. The cathode current collector 22 has a functionality of a current collector of the cathode. In the roll, the opposing parts in the cathode uncoated portion 22A of the cathode current collector 22 are pressed together to form the cathode current collector portion 20A.

The cathode mixture layer 23 is formed by curing a cathode mixture paste, which is in a liquid form. The cathode mixture paste contains a cathode active material, a cathode solvent, a cathode conductive material, and a cathode binder. The cathode mixture paste is dried and the cathode solvent is vaporized to form the cathode mixture layer 23. Accordingly, the cathode mixture layer 23 contains the cathode active material, the cathode conductive material, and the cathode binder.

The cathode active material includes a lithium-containing composite oxide that allows for the storage and release of lithium ions, which serve as the charge carrier of the lithium-ion rechargeable battery 10. A lithium-containing composite oxide may be an oxide that contains lithium and a metal element other than lithium. The metal element other than lithium may be at least one selected from a group consisting of, for example, nickel, cobalt, manganese, vanadium, magnesium, molybdenum, niobium, titanium, tungsten, aluminum, and iron contained as iron phosphate in the lithium-containing composite oxide.

The lithium-containing composite oxide may include, for example, any one of or a combination of lithium cobalt oxide (LiCoO₂), lithium nickel oxide (LiNiO₂), lithium manganese oxide (LiMn₂O₄), lithium nickel cobalt manganese oxide (LiNiCoMnO₂), lithium iron phosphate (LiFePO₄), and the like. The lithium nickel cobalt manganese oxide (LiNiCoMnO₂) is a three-element lithium-containing composite oxide that contains nickel, cobalt, and manganese.

The cathode solvent includes an N-methyl-2-pyrrolidone (NMP) solution, which is an example of an organic solvent. The NMP of the cathode solvent contains hydroxy-NMP. Hydroxy-NMP is 5-hydroxy-N-methyl-2-pyrrolidinone. The ratio of the hydroxy-NMP contained in the NMP, which serves as a solvent, is between 215 ppm and 1300 ppm, inclusive. The cathode conductive material includes a fibrous conductive material. The fibrous conductive material includes, for example, carbon nanotubes. The cathode binder is an example of a resin component contained in the cathode mixture paste. The cathode binder includes, for example, polyvinylidene fluoride (PVDF), polyvinyl alcohol (PVA), styrene-butadiene rubber (SBR), or the like.

In the cathode mixture layer 23, in which the cathode mixture paste is dried and the cathode solvent is vaporized, the amount of the hydroxy-NMP per unit area of the cathode active material is between 0.0026 μg/cm² and 0.0150 μg/cm², inclusive.

The cathode sheet 21 may include an insulation layer at the boundary between the cathode uncoated portion 22A and the cathode mixture layer 23. The insulation layer includes an insulative inorganic component and a resin component that has a functionality of a binder. The inorganic component includes at least one selected from a group consisting of boehmite, titania, and alumina that are in powder form. The resin component includes at least one selected from a group consisting of PVDF, PVA, and acrylic.

### Anode Sheet 24

The anode sheet 24 includes an anode current collector 25 and an anode mixture layer 26. The anode current collector 25 is a strip of an anode substrate foil. The anode mixture layer 26 is arranged on each of the two opposing surfaces of the anode current collector 25. One end of the anode current collector 25 in the widthwise direction D2 at the side opposite to the cathode uncoated portion 22A includes an anode uncoated portion 25A where the anode mixture layer 26 is not formed such that the anode current collector 25 is exposed.

The anode current collector 25 may be a foil of a metal such as copper or an alloy having copper as a main component. The anode current collector 25 has a functionality of a current collector of the anode. In the roll, the opposing parts in the anode uncoated portion 25A are pressed together to form the anode current collector portion 20B.

The anode mixture layer 26 is formed by curing an anode mixture paste, which is in a liquid form. The anode mixture paste includes an anode active material, an anode solvent, an anode thickener, and an anode binder. The anode mixture paste is dried and the anode solvent is vaporized to form the anode mixture layer 26. Accordingly, the anode mixture layer 26 includes the anode active material and the additives of the anode thickener and the anode binder. The anode mixture layer 26 may further include an additive such as a conductive material.

The anode active material allows for the storage and release of lithium ions. The anode active material includes, for example, a carbon material such as graphite, hard carbon, soft carbon, carbon nanotubes, or the like. An example of the anode solvent is water. An example of the anode thickener may include carboxymethyl cellulose (CMC) as a thickener containing a sodium salt. The anode binder may be the same material as the cathode binder. The anode binder may include SAR (styrene acrylic rubber), or styrene acrylate copolymer as an example of a binder containing a sodium salt.

### Separator 27

The separators 27 prevent contact between the cathode sheet 21 and the anode sheet 24 in addition to holding the non-aqueous electrolyte solution between the cathode sheet 21 and the anode sheet 24. Immersion of the electrode body 20 in the non-aqueous electrolyte solution results in the non-aqueous electrolyte solution permeating each separator 27 from the ends in the widthwise direction D2 toward the center.

Each separator 27 is a nonwoven fabric of polypropylene or the like. The separator 27 may include, for example, a porous polymer film such as a porous polyethylene film, a porous polyolefin film, a porous polyvinyl chloride film, or the like. Alternatively, the separator 27 may include an ion conductive polymer electrolyte film or the like.

### Non-Aqueous Electrolyte Solution

The non-aqueous electrolyte solution is a composition containing a supporting electrolyte in a non-aqueous solvent. The non-aqueous solvent may include one or two or more selected from a group consisting of propylene carbonate, ethylene carbonate, diethyl carbonate, dimethyl carbonate, ethyl methyl carbonate, and the like. The supporting electrolyte may include a lithium compound (lithium salt) of one or two or more selected from a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, lithium bis(oxalate) borate (LiBOB), and the like.

In the present embodiment, ethylene carbonate is used as the non-aqueous solvent. LiBOB, which is a lithium salt serving as a film forming agent, is added to the non-aqueous electrolyte solution. For example, LiBOB is added to the non-aqueous electrolyte solution so that the LiBOB in the non-aqueous electrolyte solution has a concentration between 0.001 mol/L and 0.1 mol/L, inclusive.

A case in which the cathode solvent does not include hydroxy-NMP will now be described.

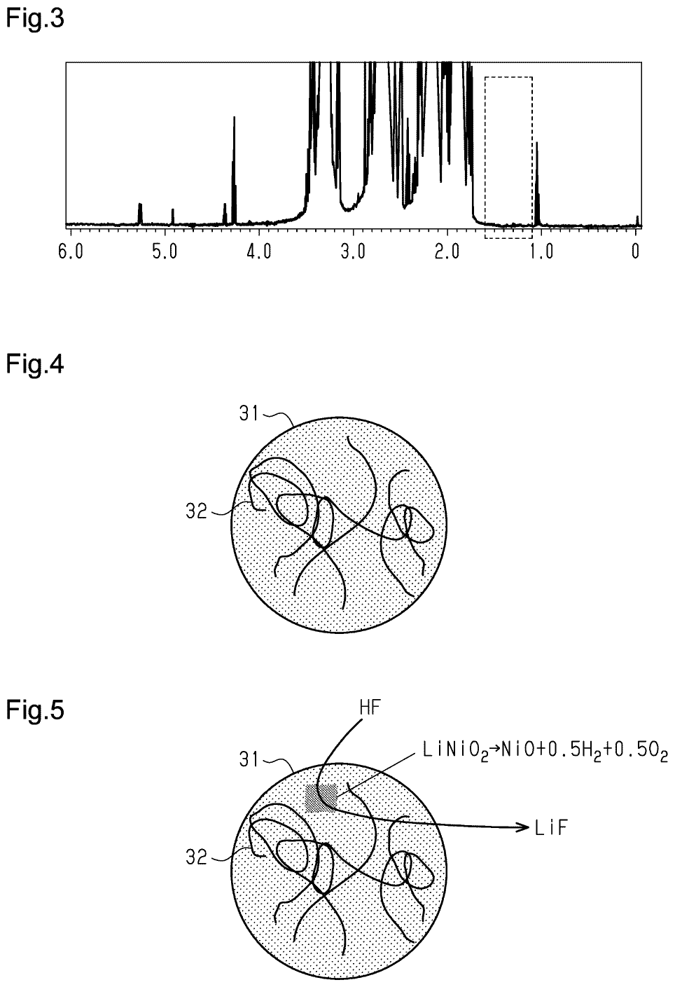

FIG. 3 shows a nuclear magnetic resonance (NMR) spectrum of a cathode solvent in which hydroxy-NMP is not present. The NMR spectrum corresponds to 1H-NMR spectrum. When hydroxy-NMP is absent, a peak (signal) is not detected in a chemical shift between 1.0 ppm and 1.6 ppm, inclusive, which is indicated by the broken lines.

FIG. 4 shows the surface of the cathode active material 31 of the cathode mixture layer forming the cathode sheet on which the fibrous conductive material 32 is present and hydroxy-NMP is not present. The fibrous conductive material 32 is adhered to the surface of the cathode active material 31 and connects particles of the cathode active material 31.

As shown in FIG. 5, when the non-aqueous rechargeable battery is energized, the non-aqueous electrolyte solution decomposes and produces acid. The acid reacts with the cathode active material 31 to form a deterioration layer on the surface of the cathode sheet. For example, when the acid produced by decomposition of the non-aqueous electrolyte solution is hydrogen fluoride (HF), and the cathode active material 31 is lithium nickel oxide (LiNiO₂), a decomposition reaction of the following expression (1) occurs. In expression (1), “NiO” represents a deterioration layer.

$$HF + L i N i {O}_{2} \to L i F + N i O + 0.5 {H}_{2} + 0.5 {O}_{2} \qquad ( 1 )$$

A case in which the cathode solvent contains hydroxy-NMP will now be described.

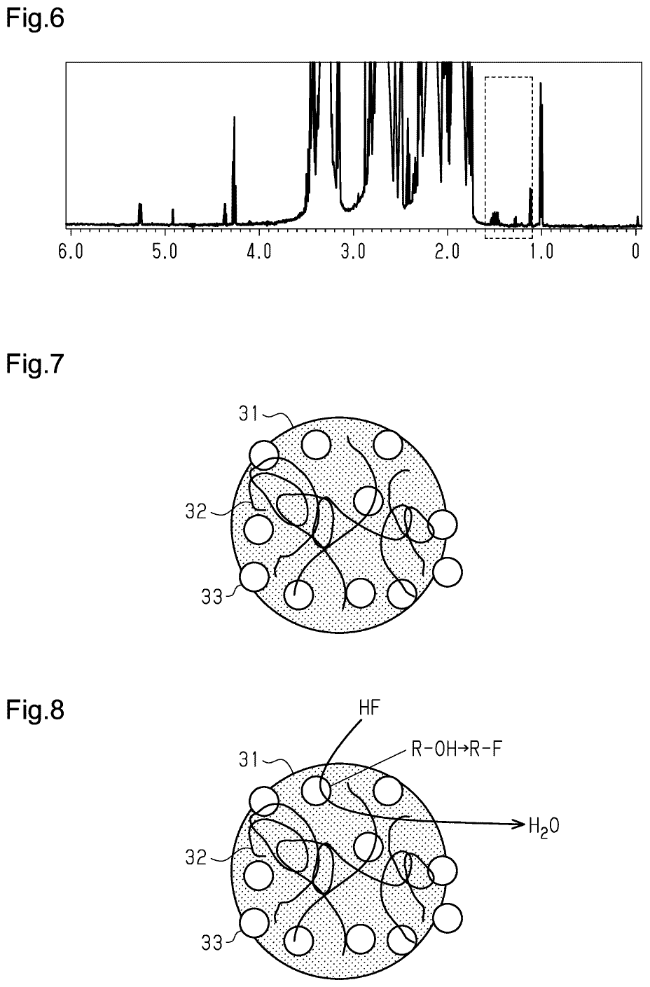

FIG. 6 shows an NMR spectrum of the cathode solvent in which hydroxy-NMP is present. When the hydroxy-NMP is present, a peak (signal) is detected in a chemical shift between 1.1 ppm and 1.6 ppm, inclusive, which is shown by the broken lines.

FIG. 7 shows that the surface of the cathode active material 31 of the cathode mixture layer forming the cathode sheet on which the fibrous conductive material 32 and a hydroxy-NMP 33 are present. The fibrous conductive material 32 is adhered to the surface of the cathode active material 31 and connects particles of the cathode active material 31. The hydroxy-NMP 33 is adhered to the surface of the cathode active material 31.

As shown in FIG. 8, when the non-aqueous rechargeable battery is energized, the non-aqueous electrolyte solution decomposes and produces acid. The acid reacts with the hydroxy-NMP so that a deteriorated layer will not be formed on the surface of the cathode sheet. For example, when the acid produced by decomposition of the non-aqueous electrolyte solution is hydrogen fluoride (HF), and the hydroxy group is denoted by “R—OH”, a decomposition reaction of the following expression (2) occurs.

$$HF + R - OH \to R - F + {H}_{2} O \qquad ( 2 )$$

### Manufacturing Method

A method for manufacturing the lithium-ion rechargeable battery 10 will now be described. Specifically, a method for manufacturing the cathode sheet 21 will be described.

The method for manufacturing the lithium-ion rechargeable battery 10 includes an application step of applying the cathode mixture paste to the cathode current collector 22 and a drying step of drying the cathode mixture paste. The cathode mixture paste contains a cathode active material, a cathode solvent, a cathode conductive material, and a cathode binder. In the drying step, the cathode mixture paste is dried and the cathode solvent is vaporized to form the cathode mixture layer 23.

As shown in FIG. 7, the cathode mixture layer forming the cathode sheet contains the cathode active material 31, the fibrous conductive material 32, and the hydroxy-NMP 33. The fibrous conductive material 32 and the hydroxy-NMP 33 are adhered to the surface of the cathode active material 31.

The fibrous conductive material has an average fiber length between 100 nm and 1000 nm, inclusive. If the average fiber length of the fibrous conductive material is less than 100 nm, conductivity will be insufficient. If the average fiber length of the fibrous conductive material is greater than 1000 nm, the intermolecular forces and hydrogen bonding between the fibers may cause aggregation of the fibers such that sufficient conductivity will not be ensured.

The ratio of the fibrous conductive material contained in the cathode mixture layer 23 is between 0.5 wt % and 1.0 wt %, inclusive. If the ratio of the fibrous conductive material contained in the cathode mixture layer 23 is less than 0.5 wt %, the reaction resistance will be appropriate. However, exposure of the active surface of the cathode active material will be increased such that deterioration may not be sufficiently restricted. If the ratio of the fibrous conductive material contained in the cathode mixture layer 23 is greater than 1.0 wt %, the coating will restrict deterioration. However, a reduction in the reaction area may lead to insufficient input and output.

The cathode active material has a specific surface area between 1.7 m²/g and 2.5 m²/g, inclusive. If the specific surface area of the cathode active material is less than 1.7 m²/g, a reduction in the reaction area may increase the reaction resistance and lead to insufficient input and output. If the specific surface area of the cathode active material is greater than 2.5 m²/g, deterioration caused by the side reactions may not be sufficiently restricted. Preferably, the specific surface area of the cathode active material is between 2.0 m²/g and 2.4 m²/g, inclusive.

The average fiber length of the fibrous conductive material 32 is obtained as follows. The cathode mixture paste is centrifuged to precipitate the cathode active material 31. Then, the supernatant liquid is collected and further diluted. The fibrous conductive material 32 contained in the diluted supernatant liquid is dispersed, and SEM images of the dispersed fibrous conductive material 32 are captured at multiple locations. Each fiber of the fibrous conductive material 32 captured in the SEM images is traced to quantify the length through an image analysis. Thus, measurement can be performed even when the fibrous conductive material 32 includes curved fibers. A parameter for calculating the average length corresponds to an average number of traced fibers of the fibrous conductive material 32. When obtaining fiber lengths from an undiluted solution of the fibrous conductive material 32, the undiluted solution of the fibrous conductive material 32 is diluted, and SEM images of the fibrous conductive material 32 contained in the diluted solution are captured at multiple locations. Then, the lengths are measured in the same manner as described above. Alternatively, when obtaining fiber lengths from the fibrous conductive material 32 contained in the cathode mixture, the cathode mixture is dissolved with a solvent such as an NMP, and the dissolved cathode mixture is centrifuged to precipitate the cathode active material. Then, the supernatant liquid is collected and further diluted. The fibrous conductive material 32 contained in the diluted supernatant liquid is dispersed, and SEM images of the dispersed fibrous conductive material 32 are captured at multiple locations to obtain the measurement in the same manner as described above. The centrifugation is performed under conditions in which, for example, the number of rotations is 15000 rpm, the centrifugal force is 21500 g, and the processing time is 10 min. If the fibrous conductive material 32 is not easily cut, the measured average fiber length of the fibrous conductive material 32 will be the same between the undiluted solution of the fibrous conductive material 32, the cathode mixture paste, and the cathode mixture.

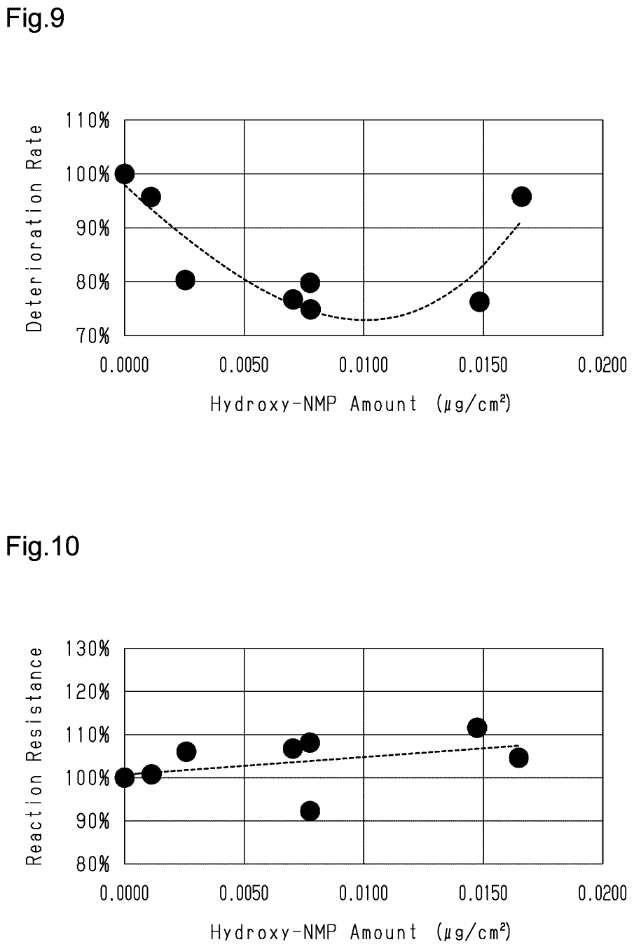

As shown in FIG. 9, when hydroxy-NMP is contained in the NMP, which serves as a solvent, a deterioration rate decreases. In particular, the deterioration rate is the lowest when the amount of the hydroxy-NMP present per unit area of the cathode active material is approximately 0.0100 μg/cm². If the amount of the hydroxy-NMP present per unit area of the cathode active material is relatively small, deterioration will not be sufficiently restricted.

As shown in FIG. 10, when hydroxy-NMP is contained in the NMP, which serves as a solvent, the reaction resistance increases in proportion to the amount of the hydroxy-NMP present per unit area of the cathode active material. In other words, if the amount of hydroxy-NMP present per unit area of the cathode active material is relatively large, deintercalation and intercalation of Li through the surface of the cathode active material will be inhibited, which in turn, increases the reaction resistance.

Therefore, it is desirable that the amount of the hydroxy-NMP present per unit area of the cathode active material be between 0.0026 μg/cm² and 0.0150 μg/cm², inclusive. In other words, it is desirable that the amount of the hydroxy-NMP contained in the NMP, which serves as a solvent, is set in a range such that the deterioration rate is less than 90% and the reaction resistance is less than 110%. In this manner, the fibrous conductive material contained in the cathode mixture layer restricts deterioration of the cathode, which would be caused by the acid produced during decomposition reaction of the non-aqueous electrolyte solution, while improving the capacity and the input/output.

The present embodiment has the following advantages.

(1) The amount of the hydroxy-NMP present per unit area of the cathode active material is between 0.0026 μg/cm² and 0.0150 μg/cm², inclusive. Thus, the acid produced by decomposition reaction of the non-aqueous electrolyte solution reacts with the hydroxy-NMP. In this manner, the fibrous conductive material restricts deterioration of the cathode, which would be caused by the acid produced during decomposition reaction of the non-aqueous electrolyte solution, while improving the capacity and the input/output.

(2) The fibrous conductive material has the average fiber length between 100 nm and 1000 nm, inclusive. This avoids reaggregation of the fibrous conductive material and limits increases in the viscosity of the cathode mixture. The ratio of the fibrous conductive material contained in the cathode mixture is between 0.5 wt % and 1.0 wt %, inclusive. Thus, the ratio of the cathode active material will not be decreased by a large amount of the conductive material, thereby ensuring the capacity. This obtains both the productivity and the battery performance.

(3) The cathode active material has the specific surface area between 1.7 m²/g and 2.5 m²/g, inclusive. This ensures the reaction area and limits increases in the reaction resistance by a reduction in the reaction area while restricting deterioration that would be caused by side reactions of the cathode active material and the non-aqueous electrolyte solution.

(4) The ratio of the hydroxy-NMP contained in the NMP, which serves as a solvent, is between 215 ppm and 1300 ppm, inclusive. Thus, the acid produced by decomposition reaction of the non-aqueous electrolyte solution reacts with the hydroxy-NMP. In this manner, the fibrous conductive material restricts deterioration of the cathode, which would be caused by the acid produced during decomposition reaction of the non-aqueous electrolyte solution, while improving the capacity and the input/output.

### OTHER EMBODIMENTS

The above embodiment may be modified as follows. The above embodiment and the following modifications can be combined as long as the combined modifications remain technically consistent with each other.

In the above embodiment, carbon nanotubes are used as the fibrous conductive material 32. Instead, carbon nanofibers may be used as the fibrous conductive material 32.

In the above embodiment, the electrode body 20 is a roll formed by rolling a stack of the cathode sheet 21, the anode sheet 24, and the separators 27. Instead, the electrode body may be a stack of cathode sheets 21 and anode sheets 24 that are alternately arranged with a separator 27 disposed in between.

The lithium-ion rechargeable battery 10 may be used in an automatic transporting vehicle, a special hauling vehicle, a battery electric vehicle, a hybrid electric vehicle, a computer, an electronic device, or any other system. For example, the lithium-ion rechargeable battery 10 may be used in a marine vessel, an aircraft, or any other type of movable body. The lithium-ion rechargeable battery 10 may also be used in a system that supplies electric power from a power plant via a substation to buildings and households.

### EXAMPLES

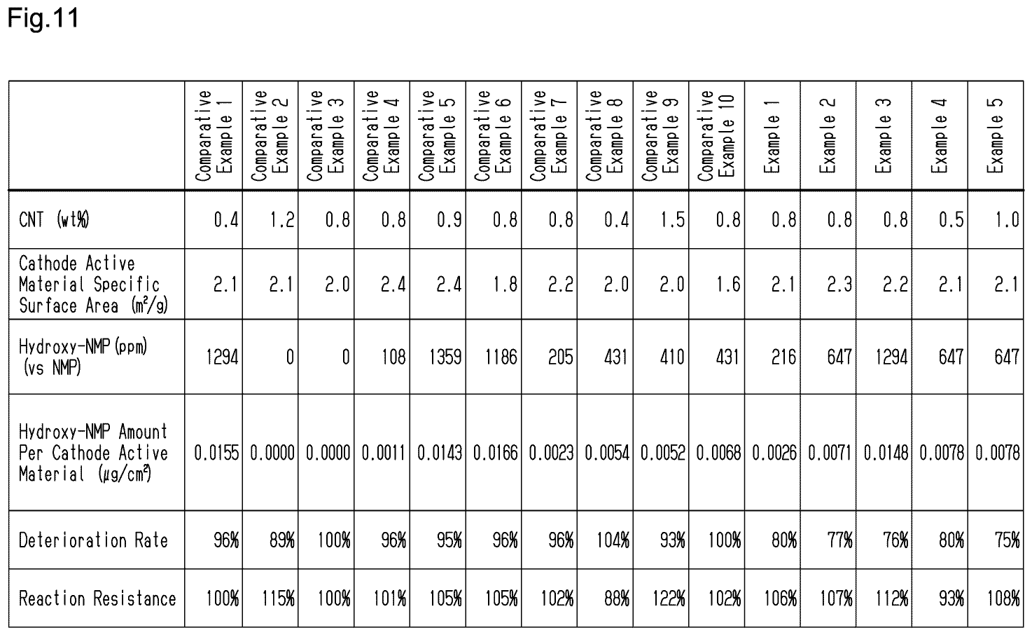

Examples and Comparative Examples of the lithium-ion rechargeable battery 10 will now be described with reference to FIG. 11. Examples and Comparative Examples are not intended to limit the non-aqueous rechargeable battery and the method for manufacturing the non-aqueous rechargeable battery.

As shown in FIG. 11, Examples and Comparative Examples of lithium-ion rechargeable batteries 10 were prepared by varying combinations of the ratio of the fibrous conductive material (CNT) 32 contained in the cathode mixture, the specific surface area of the cathode active material, the ratio of the hydroxy-NMP contained in the NMP, and the amount of the hydroxy-NMP present per unit area of the cathode active material. Then, Examples and Comparative Examples were evaluated for the deterioration rate and the reaction resistance.

### Comparative Example 1

The ratio of the fibrous conductive material contained in the cathode mixture was set to 0.4 wt %, the specific surface area of the cathode active material was set to 2.1 m²/g, the ratio of the hydroxy-NMP contained in the NMP was set to 1294 ppm, and the amount of the hydroxy-NMP present per unit area of the cathode active material was set to 0.0155 μg/cm².

### Comparative Example 2

The ratio of the fibrous conductive material contained in the cathode mixture was set to 1.2 wt %, the specific surface area of the cathode active material was set to 2.1 m²/g, the ratio of the hydroxy-NMP contained in the NMP was set to 0 ppm, and the amount of the hydroxy-NMP present per unit area of the cathode active material was set to 0.0000 μg/cm².

### Comparative Example 3

The ratio of the fibrous conductive material contained in the cathode mixture was set to 0.8 wt %, the specific surface area of the cathode active material was set to 2.0 m²/g, the ratio of the hydroxy-NMP contained in the NMP was set to 0 ppm, and the amount of the hydroxy-NMP present per unit area of the cathode active material was set to 0.0000 μg/cm².

### Comparative Example 4

The ratio of the fibrous conductive material contained in the cathode mixture was set to 0.8 wt %, the specific surface area of the cathode active material was set to 2.4 m²/g, the ratio of the hydroxy-NMP contained in the NMP was set to 108 ppm, and the amount of the hydroxy-NMP present per unit area of the cathode active material was set to 0.0011 μg/cm².

### Comparative Example 5

The ratio of the fibrous conductive material contained in the cathode mixture was set to 0.9 wt %, the specific surface area of the cathode active material was set to 2.4 m²/g, the ratio of the hydroxy-NMP contained in the NMP was set to 1359 ppm, and the amount of the hydroxy-NMP present per unit area of the cathode active material was set to 0.0143 μg/cm².

### Comparative Example 6

The ratio of the fibrous conductive material contained in the cathode mixture was set to 0.8 wt %, the specific surface area of the cathode active material was set to 1.8 m²/g, the ratio of the hydroxy-NMP contained in the NMP was set to 1186 ppm, and the amount of the hydroxy-NMP present per unit area of the cathode active material was set to 0.0166 μg/cm².

### Comparative Example 7

The ratio of the fibrous conductive material contained in the cathode mixture was set to 0.8 wt %, the specific surface area of the cathode active material was set to 2.2 m²/g, the ratio of the hydroxy-NMP contained in the NMP was set to 205 ppm, and the amount of the hydroxy-NMP present per unit area of the cathode active material was set to 0.0023 μg/cm².

### Comparative Example 8

The ratio of the fibrous conductive material contained in the cathode mixture was set to 0.4 wt %, the specific surface area of the cathode active material was set to 2.0 m²/g, the ratio of the hydroxy-NMP contained in the NMP was set to 431 ppm, and the amount of the hydroxy-NMP present per unit area of the cathode active material was set to 0.0054 μg/cm².

### Comparative Example 9

The ratio of the fibrous conductive material contained in the cathode mixture was set to 1.5 wt %, the specific surface area of the cathode active material was set to 2.0 m²/g, the ratio of the hydroxy-NMP contained in the NMP was set to 410 ppm, and the amount of the hydroxy-NMP present per unit area of the cathode active material was set to 0.0052 μg/cm².

### Comparative Example 10

The ratio of the fibrous conductive material contained in the cathode mixture was set to 0.8 wt %, the specific surface area of the cathode active material was set to 1.6 m²/g, the ratio of the hydroxy-NMP contained in the NMP was set to 431 ppm, and the amount of the hydroxy-NMP present per unit area of the cathode active material was set to 0.0068 μg/cm².

### Example 1

The ratio of the fibrous conductive material contained in the cathode mixture was set to 0.8 wt %, the specific surface area of the cathode active material was set to 2.1 m²/g, the ratio of the hydroxy-NMP contained in the NMP was set to 216 ppm, and the amount of the hydroxy-NMP present per unit area of the cathode active material was set to 0.0026 μg/cm².

### Example 2

The ratio of the fibrous conductive material contained in the cathode mixture was set to 0.8 wt %, the specific surface area of the cathode active material was set to 2.3 m²/g, the ratio of the hydroxy-NMP contained in the NMP was set to 647 ppm, and the amount of the hydroxy-NMP present per unit area of the cathode active material was set to 0.0071 μg/cm².

### Example 3

The ratio of the fibrous conductive material contained in the cathode mixture was set to 0.8 wt %, the specific surface area of the cathode active material was set to 2.2 m²/g, the ratio of the hydroxy-NMP contained in the NMP was set to 1294 ppm, and the amount of the hydroxy-NMP present per unit area of the cathode active material was set to 0.0148 μg/cm².

### Example 4

The ratio of the fibrous conductive material contained in the cathode mixture was set to 0.5 wt %, the specific surface area of the cathode active material was set to 2.1 m²/g, the ratio of the hydroxy-NMP contained in the NMP was set to 647 ppm, and the amount of the hydroxy-NMP present per unit area of the cathode active material was set to 0.0078 μg/cm².

### Example 5

The ratio of the fibrous conductive material contained in the cathode mixture was set to 1.0 wt %, the specific surface area of the cathode active material was set to 2.1 m²/g, the ratio of the hydroxy-NMP contained in the NMP was set to 647 ppm, and the amount of the hydroxy-NMP present per unit area of the cathode active material was set to 0.0078 μg/cm².

### Evaluations

Examples and Comparative Examples were evaluated for the deterioration rate and the reaction resistance.

References of comparison were set to the deterioration rate and the reaction resistance in Comparative Example 3 in which the ratio of the fibrous conductive material contained in the cathode mixture layer 23 was in a range of 0.5 wt % to 1.0 wt %, the specific surface area of the cathode active material was in a range of 1.7 m²/g to 2.5 m²/g, and the NMP did not include hydroxy-NMP.

In Comparative Example 1, in which the ratio of the fibrous conductive material contained in the cathode mixture layer 23 was less than 0.5 wt %, the specific surface area of the cathode active material was in a range of 1.7 m²/g to 2.5 m²/g, the ratio of the hydroxy-NMP contained in the NMP was in a range of 215 ppm to 1300 ppm, and the amount of the hydroxy-NMP contained in the NMP was greater than 0.0150 μg/cm², the deterioration rate decreased slightly and the reaction resistance did not change.

In Comparative Example 2, in which the ratio of the fibrous conductive material contained in the cathode mixture layer 23 was greater than 1.0 wt %, the specific surface area of the cathode active material was in a range of 1.7 m²/g to 2.5 m²/g, and the NMP did not include hydroxy-NMP, the deterioration rate decreased slightly and the reaction resistance increased to 115%.

In Comparative Example 4, in which the ratio of the fibrous conductive material contained in the cathode mixture layer 23 was in a range of 0.5 wt % to 1.0 wt %, the specific surface area of the cathode active material was in a range of 1.7 m²/g to 2.5 m²/g, the ratio of the hydroxy-NMP contained in the NMP was less than 215 ppm, and the amount of the hydroxy-NMP contained in the NMP was less than 0.0026 g/cm², the deterioration rate decreased slightly and the reaction resistance was substantially the same.

In Comparative Example 5, in which the ratio of the fibrous conductive material contained in the cathode mixture layer 23 was in a range of 0.5 wt % to 1.0 wt %, the specific surface area of the cathode active material was in a range of 1.7 m²/g to 2.5 m²/g, the ratio of the hydroxy-NMP contained in the NMP was greater than 1300 ppm, the amount of the hydroxy-NMP contained in the NMP was in a range of 0.0026 μg/cm² to 0.0150 g/cm², the deterioration rate decreased slightly and the reaction resistance was substantially the same.

In Comparative Example 6, in which the ratio of the fibrous conductive material contained in the cathode mixture layer 23 was in a range of 0.5 wt % to 1.0 wt %, the specific surface area of the cathode active material was in a range of 1.7 m²/g to 2.5 m²/g, the ratio of the hydroxy-NMP contained in NMP was in a range of 215 ppm to 1300 ppm, and the amount of the hydroxy-NMP contained in the NMP was greater than 0.0150 μg/cm², the deterioration rate decreased slightly and the reaction resistance was substantially the same.

In Comparative Example 7, in which the ratio of the fibrous conductive material contained in the cathode mixture layer 23 was in a range of 0.5 wt % to 1.0 wt %, the specific surface area of the cathode active material was in a range of 1.7 m²/g to 2.5 m²/g, the ratio of the hydroxy-NMP contained in NMP was less than 215 ppm, and the amount of the hydroxy-NMP contained in the NMP was less than 0.0026 g/cm², the deterioration rate decreased slightly and the reaction resistance was substantially the same.

In Comparative Example 8, in which the ratio of the fibrous conductive material contained in the cathode mixture layer 23 was less than 0.5 wt %, the specific surface area of the cathode active material was in a range of 1.7 m²/g to 2.5 m²/g, the ratio of the hydroxy-NMP contained in the NMP was in a range of 215 ppm to 1300 ppm, and the amount of the hydroxy-NMP contained in the NMP was in a range of 0.0026 g/cm² to 0.0150 g/cm², the deterioration rate increased and the reaction resistance decreased.

In Comparative Example 9, in which the ratio of the fibrous conductive material contained in the cathode mixture layer 23 was greater than 1.0 wt %, the specific surface area of the cathode active material was in a range of 1.7 m²/g to 2.5 m²/g, the ratio of the hydroxy-NMP contained in the NMP was in a range of 215 ppm to 1300 ppm, and the amount of the hydroxy-NMP contained in the NMP was in a range of 0.0026 μg/cm² to 0.0150 g/cm², the deterioration rate decreased slightly and the reaction resistance increased greatly.

In Comparative Example 10 in which the ratio of the fibrous conductive material contained in the cathode mixture layer 23 was in a range of 0.5 wt % to 1.0 wt %, the specific surface area of the cathode active material was less than 1.7 m²/g, the ratio of the hydroxy-NMP contained in the NMP was in a range of 215 ppm to 1300 ppm, and the amount of the hydroxy-NMP contained in the NMP was in a range of 0.0026 μg/cm² to 0.0150 g/cm², the deterioration rate did not change and the reaction resistance was substantially the same.

In Examples 1 to 5, in which the ratio of the fibrous conductive material contained in the cathode mixture layer 23 was in a range of 0.5 wt % to 1.0 wt %, the specific surface area of the cathode active material was in a range of 1.7 m²/g to 2.5 m²/g, the ratio of the hydroxy-NMP contained in the NMP was in a range of 215 ppm to 1300 ppm, and the amount of the hydroxy-NMP contained in the NMP was in a range of 0.0026 μg/cm² to 0.0150 μg/cm², the deterioration rate was 80% or lower, and the reaction resistance was less than 115%. Examples 1 to 5 obtained superior results that decreased the deterioration rate while limiting increases in the reaction resistance.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous rechargeable battery, comprising:
a cathode sheet;
an anode sheet; and
a non-aqueous electrolyte solution, wherein:
a cathode mixture forming the cathode sheet contains a cathode active material, a fibrous conductive material, a hydroxy-NMP, and a cathode binder; and
an amount of the hydroxy-NMP present per unit area of the cathode active material is between 0.0026 μg/cm² and 0.0150 μg/cm², inclusive.

2. The non-aqueous rechargeable battery according to claim 1, wherein:
the fibrous conductive material has an average fiber length between 100 nm and 1000 nm, inclusive; and
a ratio of the fibrous conductive material contained in the cathode mixture is between 0.5 wt % and 1.0 wt %, inclusive.

3. The non-aqueous rechargeable battery according to claim 1, wherein the cathode active material has a specific surface area between 1.7 m²/g and 2.5 m²/g, inclusive.

4. A method for manufacturing a non-aqueous rechargeable battery, the battery including a cathode sheet, an anode sheet, and a non-aqueous electrolyte solution, wherein:
a cathode mixture forming the cathode sheet contains a cathode active material, a fibrous conductive material, a hydroxy-NMP, and a cathode binder; and
a ratio of the hydroxy-NMP contained in an NMP is between 215 ppm and 1300 ppm, inclusive, the NMP serving as a solvent,
the method comprises applying a paste of the cathode mixture, liquefied with the solvent, to a cathode substrate forming the cathode sheet, and drying the paste.

5. The method according to claim 4, wherein:
the fibrous conductive material has an average fiber length between 100 nm and 1000 nm, inclusive; and
a ratio of the fibrous conductive material contained in the cathode mixture is between 0.5 wt % and 1.0 wt %, inclusive.

6. The method according to claim 4, wherein the cathode active material has a specific surface area between 1.7 m²/g and 2.5 m²/g, inclusive.
